(19) United States
(12) Patent Application Publication
(10) Pub. No.: US 2006/0092132 A1
(43) Pub. Date: May 4, 2006

(54) Orthopedically engineered cursor control device for notebook computer

(76) Inventor: Po-Tse Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/245,099

(22) Filed: Oct. 7, 2005

(30) Foreign Application Priority Data
Oct. 8, 2004 (TW) 93216014

(51) Int. Cl. G09G 5/08

(52) U.S. Cl. 345/157

(57) ABSTRACT

A cursor control device used in a notebook computer is disclosed to include a touch panel (or trackball) mounted in the right bottom (or left bottom) corner on the top side of the main member of the notebook computer for moving the cursor on the display screen with the thumb of the right hand (or the left hand), a front button and a rear button arranged on the left (or right) vertical lateral sidewall of the main member adjacent to the touch panel (or trackball) for executing drag and drop in a windows operating system, and a wheel set on the same vertical lateral sidewall for page scrolling operation control.

### BACKGROUND OF THE INVENTION

1. Field of the Invention

The present invention relates to a notebook computer and more particularly, to a cursor control device for notebook computer, which is orthopedically engineered for convenient operation with one single handle to execute drag and drop in a windows operating system.

2. Description of the Related Art

The cursor control structure of a notebook computer generally comprises a touch panel (or trackball) and two buttons, namely, the left button and the right button. Through the touch panel (or trackball) and the buttons, the user can execute drag and drop in a windows operating system. This cursor control structure is provided on a middle part of the main member of the notebook computer. As shown in FIG. 1, the notebook computer comprises a touch panel 01 disposed on the middle of the top side of the main member in front of the keyboard, and a left button 02 and a right button 03 arranged in parallel on the top side of the main member in front of the touch panel 01. According to this design, the touch panel 01 and the buttons 02 and 03 are arranged on the same horizontal plane. Normally, the user uses the forefinger to operate the touch panel 01. However, it is inconvenient to simultaneously operate the touch panel 01 and the two buttons 02 and 03 with the left or right hand.

### SUMMARY OF THE INVENTION

The present invention has been accomplished under the circumstances in view. According to the present invention, the cursor control device is used in a notebook computer, which comprises a main member and a display panel hinged to one side of the main member. The cursor control device comprises a cursor positioning device, which can be a touch panel or trackball, a first button equivalent to the left button of a computer mouse, and a second button equivalent to the right button of a computer mouse, wherein the cursor positioning device is mounted in one corner on the top side of the main member; the first button and the second button are mounted in one vertical lateral sidewall of the main member adjacent to the cursor positioning device.

According to one embodiment of the present invention, the cursor positioning device is mounted in the right bottom corner on the top side of the main member; the first button and the second button are mounted in the right vertical lateral sidewall of the main member adjacent to the cursor positioning device.

According to another embodiment of the present invention, the cursor positioning device is mounted in the left bottom corner on the top side of the main member; the first button and the second button are mounted in the left vertical lateral sidewall of the main member adjacent to the cursor positioning device.

The cursor control device further comprises a wheel mounted on the same vertical lateral sidewall of the main member between the first button and the second button for page scrolling operation control.

### BRIEF DESCRIPTION OF THE DRAWINGS

FIG. 1 is an elevational view of a conventional notebook computer.

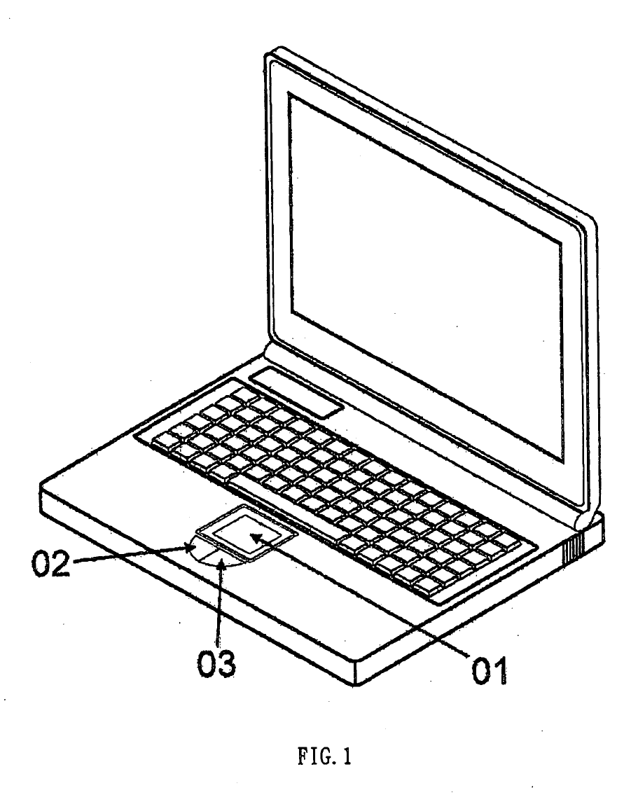

FIG. 2 is an elevational view of a notebook computer, showing the arrangement of the orthopedically engineered cursor control device according to one embodiment of the present invention.

FIG. 3 is an elevational view of a notebook computer, showing the arrangement of the orthopedically engineered cursor control device according to another embodiment of the present invention.

FIG. 4 is an elevational view of a notebook computer, showing the arrangement of the orthopedically engineered cursor control device according to still another embodiment of the present invention.

FIG. 5 is an elevational view of a notebook computer, showing the arrangement of the orthopedically engineered cursor control device according to still another embodiment of the present invention.

FIG. 6 is an elevational view of a notebook computer, showing the arrangement of the orthopedically engineered cursor control device according to still another embodiment of the present invention.

FIG. 7 is an elevational view of a notebook computer, showing the arrangement of the orthopedically engineered cursor control device according to still another embodiment of the present invention.

FIG. 8 is a schematic view showing the operation of the cursor control device of the notebook computer shown in FIG. 4 with the right hand.

FIG. 9 is a schematic view showing the operation of the cursor control device of the notebook computer shown in FIG. 5 with the right hand.

### DETAILED DESCRIPTION OF THE PREFERRED EMBODIMENT

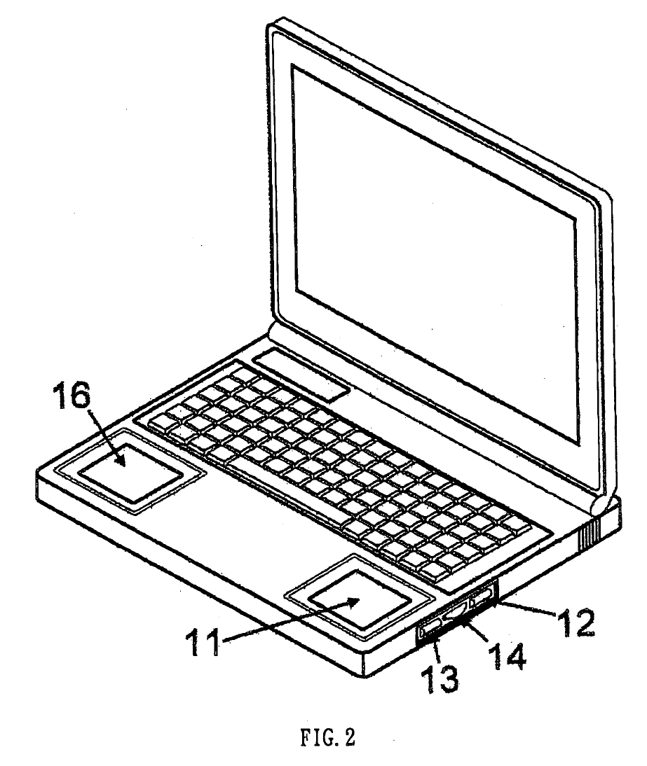

FIG. 2 is an elevational view of a notebook computer, showing the arrangement of the orthopedically engineered cursor control device according to one embodiment of the present invention. According to this embodiment, the cursor control device comprises a first touch panel 11 disposed on the top side of the main member near the right bottom corner for operation by the right hand to move the cursor on the display screen, a second touch panel 16 disposed on the top side of the main member near the left bottom corner for operation by the left hand to move the cursor on the display screen, a front button 12 (equivalent to the left button of a mouse) and a rear button 13 (equivalent to the right button of a mouse) arranged at one vertical lateral sidewall of the main member adjacent to the first touch panel 11 for operation by the right hand to execute drag and drop in a windows operating system. Further, a wheel 14 is disposed at the same vertical lateral sidewall of the main member between the front button 12 and the rear button 13 for scrolling the page.

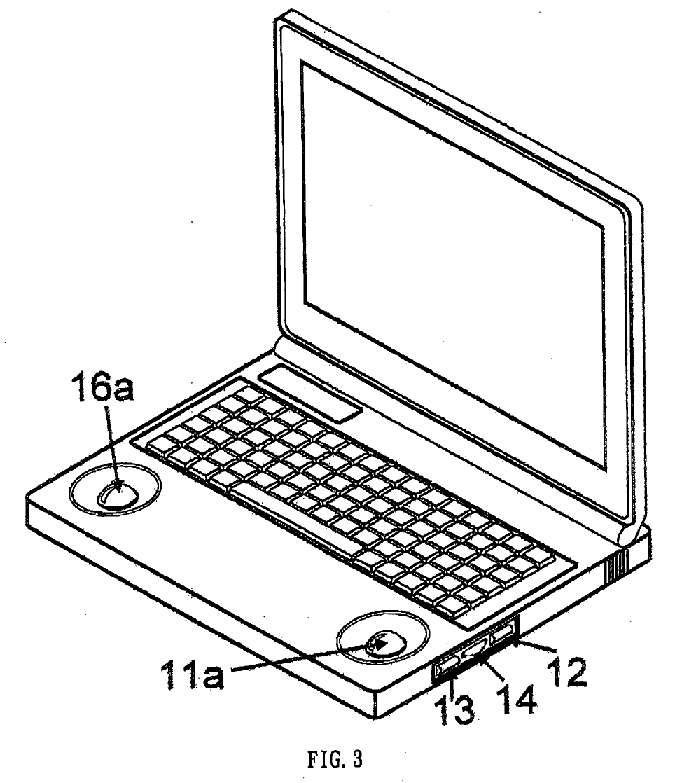

FIG. 3 is an elevational view of a notebook computer, showing the arrangement of the orthopedically engineered cursor control device according to another embodiment of the present invention. This embodiment is substantially similar to the embodiment shown in FIG. 2 with the exception that trackballs 11a and 16a are used to substitute for the aforesaid touch panels 11 and 16.

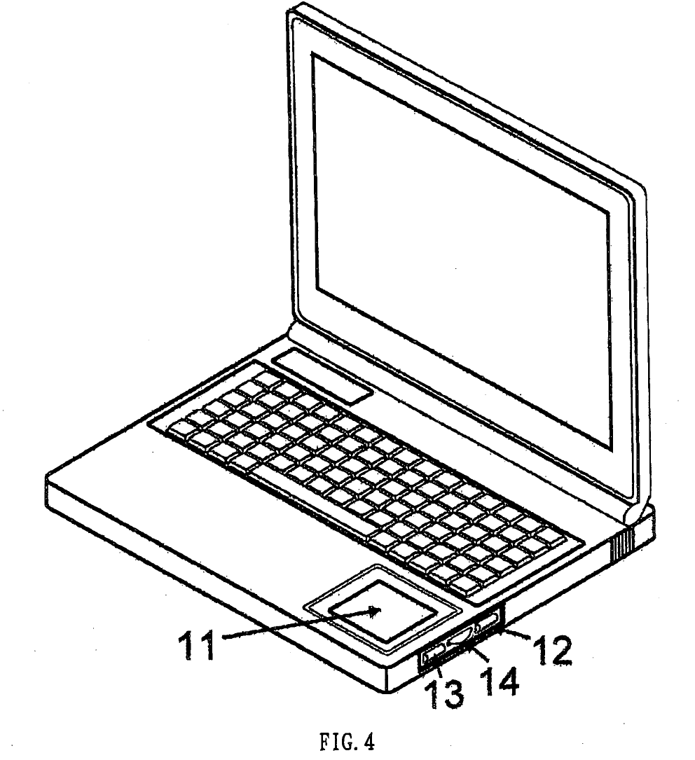

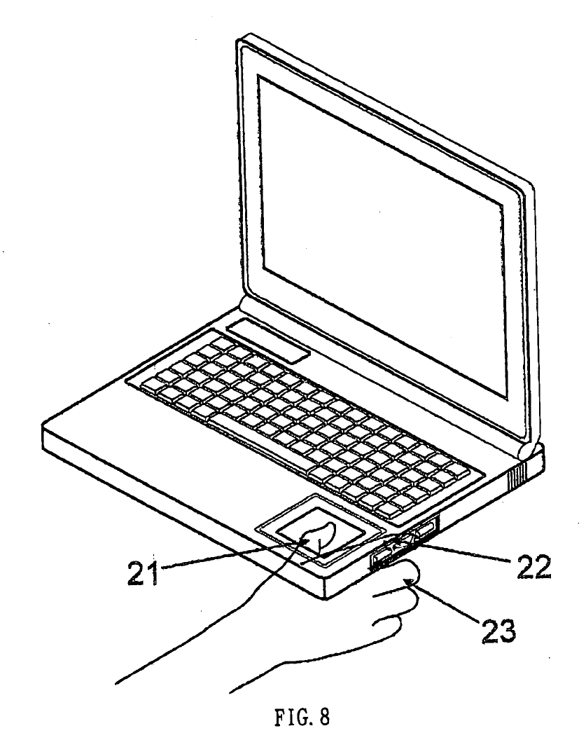

FIG. 4 is an elevational view of a notebook computer, showing the arrangement of the orthopedically engineered cursor control device according to still another embodiment of the present invention. This embodiment eliminates the second touch panel 16 from the embodiment shown in FIG. 4. When operating the cursor control device, as shown in FIG. 8, the user can operate the touch panel 11 with the thumb 21 of the right hand and simultaneously operate the front button 12 and/or the wheel 14 with the forefinger 22 of the right hand or the rear button 13 with the middle finger 23 of the right hand.

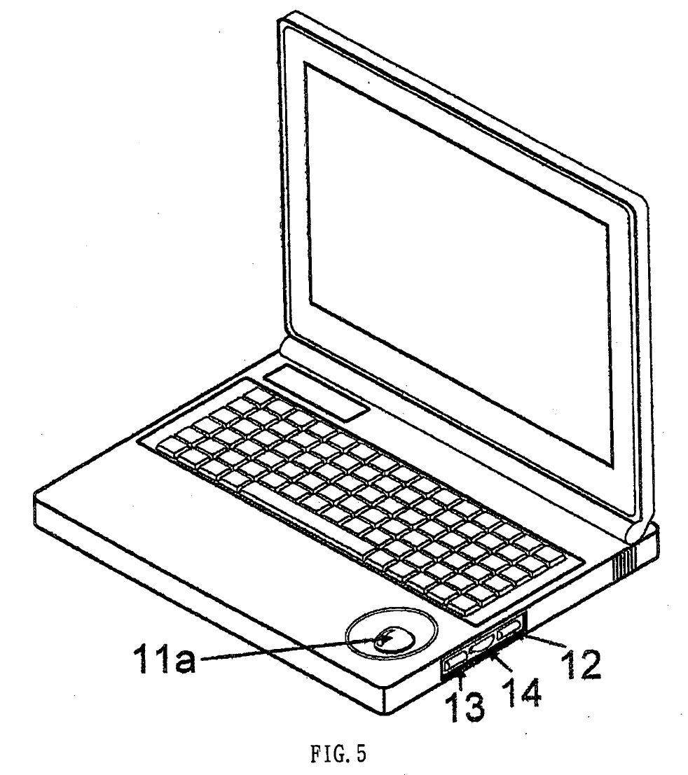

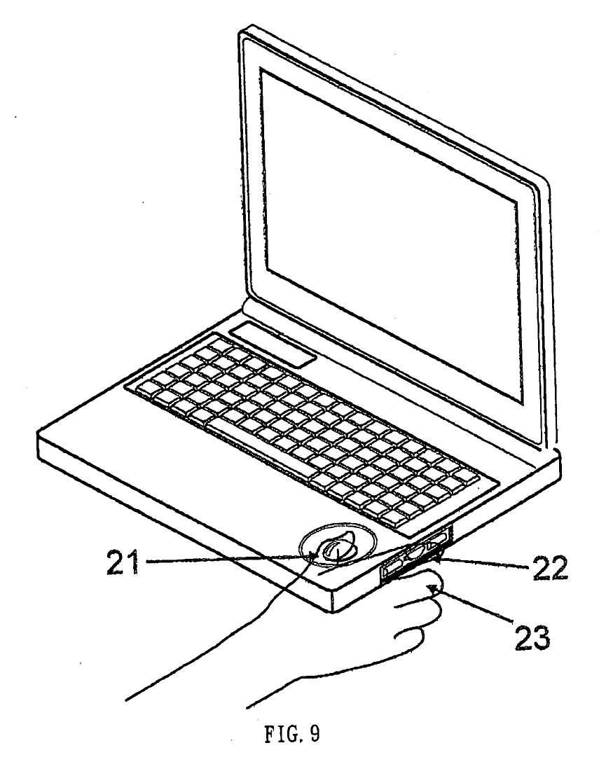

FIG. 5 is an elevational view of a notebook computer, showing the arrangement of the orthopedically engineered cursor control device according to still another embodiment of the present invention. This embodiment is substantially similar to the embodiment shown in FIG. 4 with the exception of the use of a trackball 11a to substitute for the touch panel 11. When operating the cursor control device, as shown in FIG. 9, the user can operate the trackball 11a with the thumb 21 of the right hand and simultaneously operate the front button 12 and/or the wheel 14 with the forefinger 22 of the right hand or the rear button 13 with the middle finger 23 of the right hand.

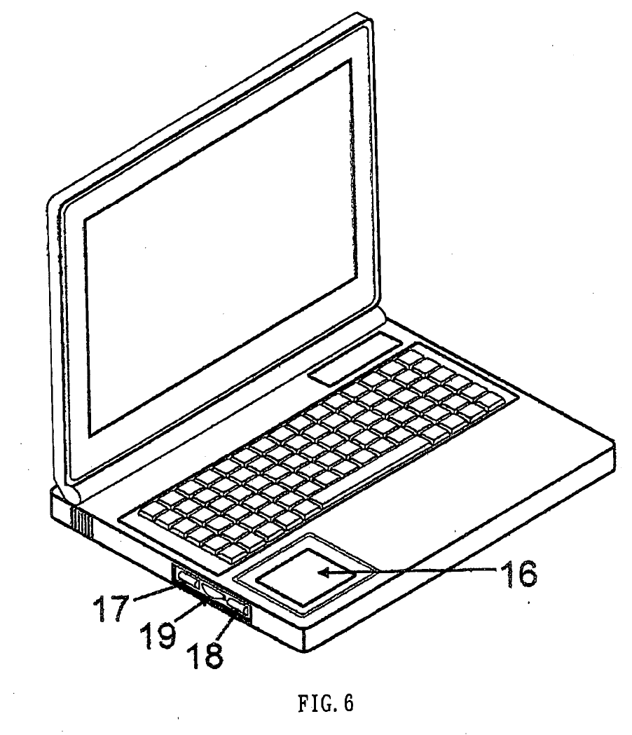

FIG. 6 is an elevational view of a notebook computer, showing the arrangement of the orthopedically engineered cursor control device according to still another embodiment of the present invention. the cursor control device comprises a first touch panel 16 disposed on the top side of the main member near the left bottom corner for operation by the left hand to move the cursor on the display screen, a front button 17 (equivalent to the left button of a mouse) and a rear button 18 (equivalent to the right button of a mouse) arranged at one vertical lateral sidewall of the main member adjacent to the touch panel 16 for operation by the left hand to execute drag and drop in a windows operating system. Further, a wheel 19 is disposed at the same vertical lateral sidewall of the main member between the front button 17 and the rear button 18 for scrolling the page.

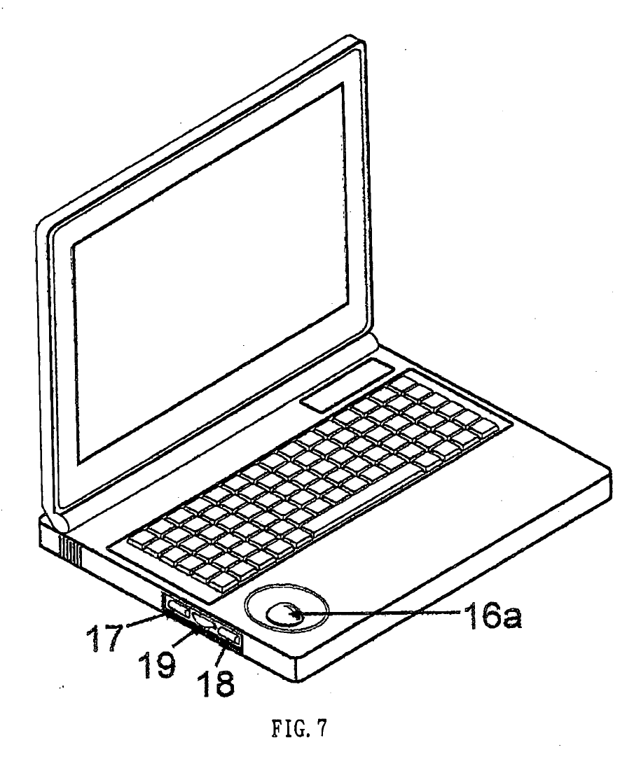

FIG. 7 is an elevational view of a notebook computer, showing the arrangement of the orthopedically engineered cursor control device according to still another embodiment of the present invention. This embodiment is substantially similar to the embodiment shown in FIG. 6 with the exception of the use of a trackball 16a to substitute for the touch panel 16.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A cursor control device used in a notebook computer, which comprises a main member and a display panel hinged to one side of said main member, the cursor control device comprising a cursor positioning device formed of one of a touch panel and a trackball, a first button equivalent to the left button of a computer mouse, and a second button equivalent to the right button of a computer mouse, wherein said cursor positioning device is mounted in one corner on a top side of said main member; said first button and said second button are mounted in one vertical lateral sidewall of said main member adjacent to said cursor positioning device.

2. The cursor control device as claimed in claim 1, wherein said cursor positioning device is mounted in a right bottom corner on said top side of said main member; said first button and said second button are mounted in a right vertical lateral sidewall of said main member adjacent to said cursor positioning device.

3. The cursor control device as claimed in claim 1, wherein said cursor positioning device is mounted in a left bottom corner on said top side of said main member; said first button and said second button are mounted in a left vertical lateral sidewall of said main member adjacent to said cursor positioning device.

4. The cursor control device as claimed in claim 1 further comprising a wheel mounted on said vertical lateral sidewall of said main member between said first button and said second button for page scrolling operation control.
